(19) United States
(12) Patent Application Publication
(10) Pub. No.: US 2005/0139662 A1
(43) Pub. Date: Jun. 30, 2005

(54) Dynamic pricing system

(75) Inventors: Jan Eglen, Terre Haute, IN (US); Tobias Switzer, Indianapolis, IN (US); Justin Bakke, Indianapolis, IN (US)

Correspondence Address: Dewayne A. Hughes;Ice Miller, One American Square, Box 82001, Indianapolis, IN, 46282-0200, US

(73) Assignee: Digonex Technologies, Inc.

(21) Appl. No.: 11/067,234

(22) Filed: Feb. 25, 2005

Related U.S. Application Data
(63) Continuation-in-part of application No. 10/084,777, filed on Feb. 27, 2002.

(51) Int. Cl. G06K 15/00

(52) U.S. Cl. 235/383

(57) ABSTRACT

A system for dynamically pricing shelved products in a physical store and/or products available for order in a virtual store. The system dynamically sends prices for a product to a price display unit positioned near the product, and receives reports of sale for the product from a checkout station. Based on the data in the reports, and the timing of the reports, the system dynamically determines the price for the product. For products available for order, the system presents the dynamic prices for the product on a terminal, and receives reports of sale from the terminal.

### REFERENCE TO RELATED APPLICATIONS

This application is a continuation-in-part of application Ser. No. 10/084,777, filed Feb. 27, 2002, which is hereby incorporated by reference.

### BACKGROUND OF THE INVENTION

The present invention generally relates to pricing systems, and more specifically, but not exclusively, concerns a pricing display system adapted to dynamically price goods in a retail establishment.

Manual and electronic methods are currently in use for displaying the prices of products in stores. For example, manual placard displays may be provided at locations where a product is shelved at the store to permit consumers to determine the price of the product. The placard displays must be manually changed each time that the prices in the checkout computers are changed so that there is no discrepancy between the prices contained in the checkout computer and the prices shown on the manual placard displays. Often times, this fails and the price on the shelf and the price in the checkout computer do not match.

Electronic pricing display systems also exist. These electronic pricing systems use machine readable bar codes to change prices, and work with a product's universal product code (UPC) symbol. Each product carries a unique bar code that identifies the manufacturer and the individual product, for example a twelve ounce can of caffeine free Diet Coke®. An electronic price display displays the price of the product at a location where the product is shelved in the store. The store also has a checkout computer and scanner. An employee with a hand held unit changes the product price at the electronic display located where the product is shelved. The changed prices are entered into the hand held unit and the person positions the hand held unit near the electronic display and presses a button so that the information is transferred to the electronic display to display the new price.

There are also a number of systems available which interconnect local store computers to the checkout stations, as well as interconnecting local store computers to the store owner's computers. Companies, such as Intactix of Dallas, Tex., are suppliers of such software and the hardware is well-known to those skilled in the art. Methods also exist for connecting a local store computer to an owner's computer.

A number of electronic display technologies are available today, such as liquid crystal displays, light emitting diode displays, flat panel video displays, and the like, which may be utilized as product displays at a products shelf location. For example, companies such as PRICER AB of Sweden and others are installing active product price units which can be controlled from the local store computer. These systems, however, still require that an employee determine prices for products, and that an employee enter pricing information for the products into the system.

Therefore, there has been a long-felt need for a system to automatically adjust pricing information in a retail environment to increase profit. With the present invention, the pricing of products and the display of the pricing of products is accomplished more efficiently.

### SUMMARY OF THE INVENTION

A system is provided for dynamically pricing shelved products in a physical store. The system dynamically sends prices for a product to a price display unit positioned near the product, and receives reports of sale for the product from a checkout station. Based on the data in the reports, and the timing of the reports, the system dynamically determines the price for the product.

In a further form, a system is provided for dynamically pricing products in a virtual store. The system dynamically sends prices for a product to terminal, and receives reports of sale for the product from the terminal. Based on the data in the reports, and the timing of the reports, the system dynamically determines the price for the product.

In a further form, a computer readable device is encoded with a program executable by a computer. The program, when executed, causes the computer to send a price of a product to a price display unit positioned near the product, and to receive a report of sale for the product from a checkout station. The program further causes the computer to determine, based on the report of sale, whether a profit at the price is less than a previous profit at a previous price, and to adjust the price of the product based on the determination. The program also causes the computer to send the adjusted price to the price display unit.

Other forms, embodiments, objects, features, advantages, benefits, and aspects of the present invention shall become apparent from the detailed drawings and description contained herein.

### BRIEF DESCRIPTION OF THE DRAWINGS

FIG. 1 is a diagrammatic view of a communication system that includes a dynamic pricing system.

FIG. 2 is a diagrammatic view of a physical store system.

FIG. 3 is a diagrammatic view of a product pricing unit.

FIG. 4 is a diagrammatic view of a store checkout station.

FIG. 5 is a diagrammatic view of a store product advertising media unit.

FIG. 6 is a table structure for the dynamic pricing system of FIG. 1.

FIG. 7 is a flow diagram illustrating a first process for dynamically pricing a product.

FIG. 8 is a flow diagram illustrating a second process for dynamically pricing a product.

FIG. 9 is a flow diagram illustrating a third process for dynamically pricing a product.

FIG. 10 is a display screen of a terminal for a virtual store.

### DESCRIPTION OF THE PRESENTLY PREFERRED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

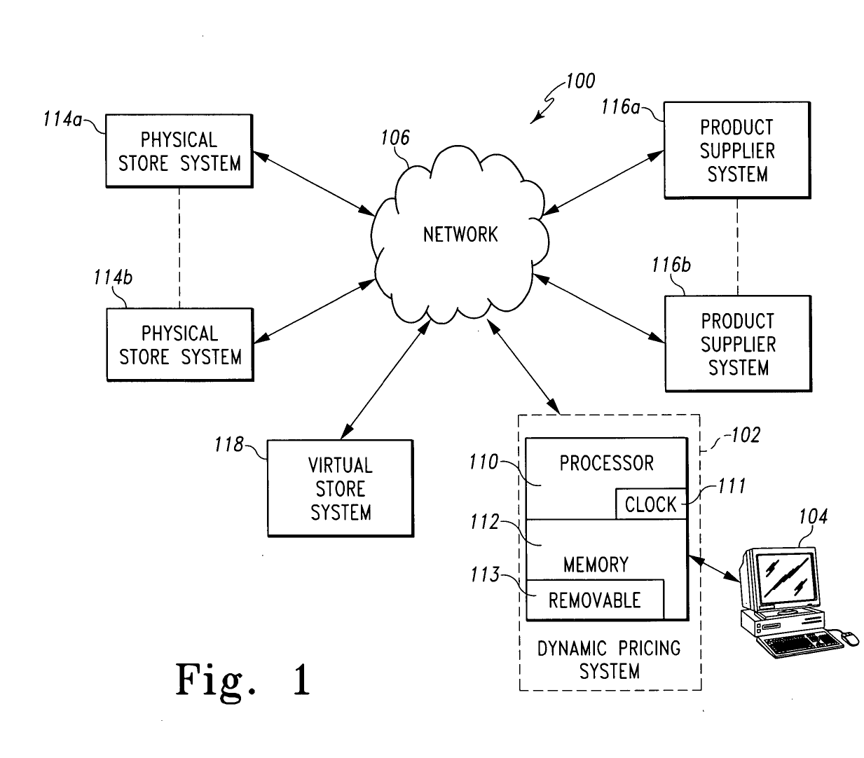

FIG. 1 depicts a communication system 100 according to one embodiment of the present invention in a diagrammatic form. The communication system 100 may include a dynamic pricing system 102, an administrative terminal 104, one or more physical store systems 114, one or more product supplier systems 116, and a virtual store system 118. An administrator of the dynamic pricing system manages the dynamic pricing system 102 with the administrative terminal 104. As illustrated, the administrative computer 104 is operatively coupled to the dynamic pricing system 102, and the dynamic pricing system 102 is operatively coupled to the other systems through the network 106. As should be appreciated, administrative computer 104 can also be operatively coupled to system 102 through the network 106. Although only one administrative computer 104 is shown in FIG. 1, it should be understood that system 100 can include multiple administrative computers 104. The administrative computer 104 can include a personal computer, a computer terminal, a personal digital assistant (PDA) and/or other types of devices generally known to those skilled in the art. In one embodiment, administrative computer 104 is a personal computer.

The dynamic pricing system 102 dynamically prices products and delivers price content to the physical store systems 114 and the virtual store system 118 over the network 106. The dynamic pricing system 102 is also operable to receive cost information from the product supplier systems 116. As should be appreciated from the discussion below, the dynamic pricing system 102 can be adapted to dynamically price a variety of goods. For instance, these goods can include, but are not limited to, compact discs, digital versatile discs, electronic products, household products, jewelry, furniture, groceries, pet supplies, and the like. As illustrated, the dynamic pricing system 102 includes a processor 110, a clock 111 and memory 112. The dynamic pricing system 102 can be located on a single server or distributed over several servers. In one embodiment, the dynamic pricing system 102 is incorporated into one or more network servers. The processor 110 is used to control the operation of the dynamic pricing system 102. The processor 110 may be comprised of one or more components. For a multi-component form of processor 110, one or more components may be located remotely relative to the others, or configured as a single unit. Furthermore, processor 110 can be embodied in a form having more than one processing unit, such as a multi-processor configuration, and should be understood to collectively refer to such configurations as well as a single-processor-based arrangement. One or more components of the processor 110 may be of electronic variety defining digital circuitry, analog circuitry, or both. Processor 110 can be of a programmable variety responsive to software instructions, a hardwired state machine, or a combination of these.

The clock 111 is used to time events in the dynamic pricing system 102. As should be appreciated, the clock 111 can be incorporated into the processor 110 or can be a stand-alone component. Further, the clock 111 can be hardware and/or software based. Among its many functions, the memory 112 in conjunction with the processor 110 is used to manage sales. Memory 112 can include one or more types of solid state memory, magnetic memory, or optical memory, just to name a few. By way of non-limiting example, the memory 112 can include solid state electronic random access memory (RAM), sequential access memory (SAM), such as first-in, first-out (FIFO) variety or last-in, first-out (LIFO) variety, programmable read only memory (PROM), electronically programmable read only memory (EPROM), or electronically erasable programmable read only memory (EEPROM); an optical disc memory (such as a DVD or CD-ROM); a magnetically encoded hard disc, floppy disc, tape, or cartridge media; or a combination of these memory types. In addition, the memory 112 may be volatile, non-volatile, or a hybrid combination of volatile, non-volatile varieties. In the illustrated embodiment, the memory 112 further includes removable memory 113. The removable memory 113 can be in the form of a non-volatile electronic memory unit, optical memory disk (such as a DVD or CD ROM); a magnetically encoded hard disk, floppy disk, tape, or cartridge media; or a combination of these or other removable memory types.

Network 106 can include the Internet, one or more other wide area networks (WAN), a local area network (LAN), a proprietary network, an institutional network, a cable television network, a public switched telephone network (PSTN), a combination of these, and/or other types of networks generally known to those skilled in the art. In one form of the present invention, the network 106 includes the Internet. As shown, the product supplier systems 116 and physical store systems 114 are operatively coupled to the network 106. The product supplier systems 116, the physical store systems 114, the virtual store system, and the dynamic pricing system 102 communicate with one another by sending signals across the network 106. In one form, these signals can include HyperText Mark Up Language (HTML) pages, Extensible Mark Up Language (XML) data, and other types transmission protocols.

By way of non-limiting examples, the product supplier systems 116, the physical store systems 114, and the virtual store systems 118 may comprise personal computers, both fixed and portable; computer terminals; PDA's; cellular telephones, land line based telephones and the like; television systems, such as televisions, television-based web browsers, digital video recorders, analog video recorders, cable boxes, cable modems; or a combination these components, to name a few examples. Only two of the physical store systems 114, and product supplier systems 116 are shown in FIG. 1 for purposes of clarity. The respective physical store systems 114 are designated in FIG. 1 by the general reference numerals 114a and 114b. The respective product supplier systems are designated in FIG. 1 by the general reference numerals 116a and 116b. As shown, the product supplier systems 116, the physical store systems 114, the virtual store system are operatively coupled to the dynamic pricing system 102 over the network 106. It should be appreciated that the product supplier systems 116, the physical store systems 114, the virtual store system can be operatively coupled to the dynamic pricing system 102 through hardwired and/or wireless connections. The product supplier systems 116, the physical store systems 114, the virtual store system are hardwired and/or have software that allows the product supplier systems 116, the physical store systems 114, the virtual store systems 118 to communicate over the network 106.

It is envisioned that the physical store systems 114 be located in establishments having product locations, such as shelves, boxes, slots, areas, or the like for storage and/or sale of products. For example, the establishments in which the physical store systems 114 are located can be retail supermarkets, drug stores, home building supply stores, inventory stocking areas or assembly sites at manufacturing or distribution facilities. It is envisioned that the product supplier systems 116 be located at establishments which serve to supply products to the stores where the physical store systems 114 are located or to a warehouse for distribution after an order is received by the virtual store system 118.

The dynamic pricing system 102 may be constructed to receive sales and inventory data from the physical store systems 114 and the virtual store system 118 via the network 106. The dynamic pricing system 102 is also constructed to receive pricing from the product supplier systems 116 via the network 106. As will be described in more detail herein below, the dynamic pricing system 102 may utilize the sales and inventory data provided by the physical store systems 114, and the virtual store system 118 and the pricing data provided by the product supplier systems 116 to automatically change product prices at the physical store systems 114 and the virtual store system 118 and to automatically order products from the product suppliers associated with the product supplier systems 116.

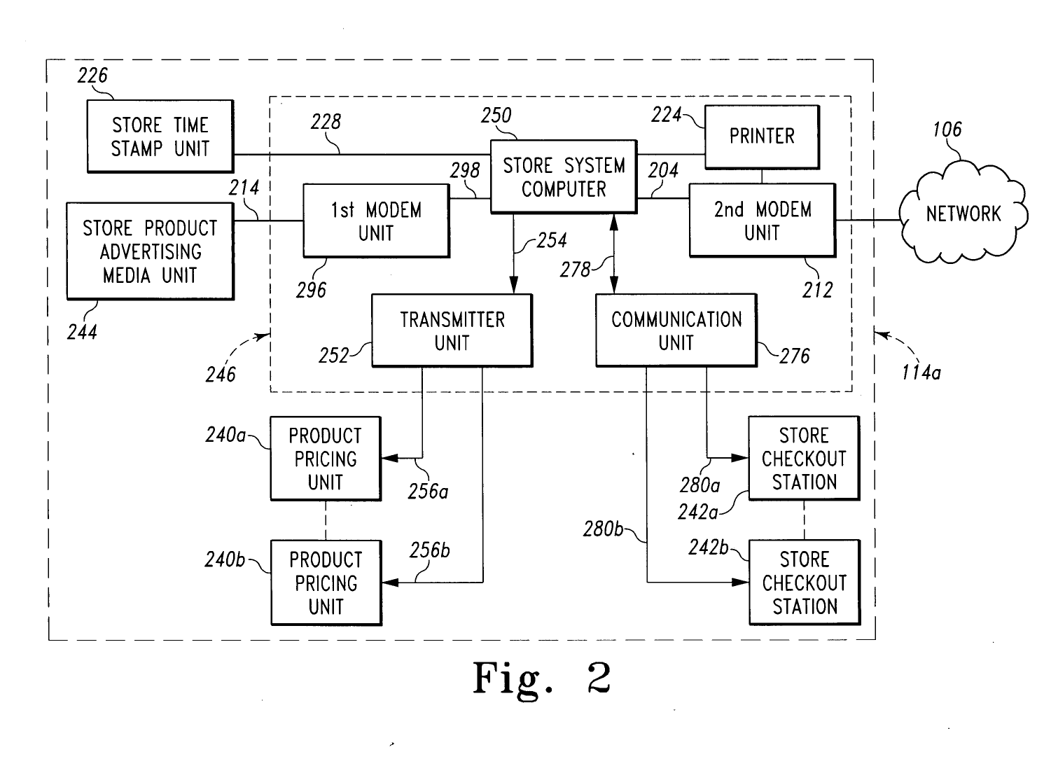

Referring now to FIG. 2, shown therein in more detail is the physical store system 114a. Because the physical store systems 114a and 114b are substantially identical in construction and function, only the physical store system 114a will be described in detail herein. The physical store system 114a, in general, may be constructed to display a product location price indicating the unit price of a product on one or more product pricing units 240, to request a product checkout price for the purchase of the product by one or more store checkout stations 242, to selectively print coupons, transmit video and/or audio advertising messages including the product checkout price on a store product advertising media unit 244, and to dynamically change the displayed product location prices, the requested product checkout prices, the coupons and the advertising messages based on real-time data, thereby substantially eliminating consumer confusion and yielding the maximum economic benefit for the physical store by a store product control system 246. The product pricing units 240 may include, by way of non-limiting example, an electronic shelf display system such as Tagnetics Price Display and Shelf Optimization system, available from Tagnetics® Inc., of Dayton Ohio.

The individual products (not shown) in the store are stamped with a machine readable code, such as the UPC (Universal Product Code) bar code. Each of the product pricing units 240 are located proximate to one of the individual products and has a unique electronic address identifying the particular product. The unique electronic address can be the UPC, the shelf location, a stock control number, or any other unique identifier. The store product control system 246 includes a store system computer 250. The store system computer 250 has stored thereon the unique electronic addresses for the respective product pricing units 240. A product location price associated with each of the unique electronic addresses is stored in the store system computer 250. The product location price is indicative of the unit price of a single product. The store system computer 250 is constructed to transmit the unique electronic addresses and the product location prices associated therewith (“electronic address and product location price data”) to a transmitter unit 252 via a signal path 254. In response to receiving the electronic address and product location price data from the store system computer 250, the transmitter unit 252 transmits such electronic address and product location price data to the respective product pricing units 240a and 240b via signal paths 256a and 256b. The signal paths 256a and 256b can be hard wiring (copper wiring, fiber optics, coaxial cable, or the like), RF wireless (microwave, low frequency, satellite, or the like) and/or optical (laser, infrared), or the like.

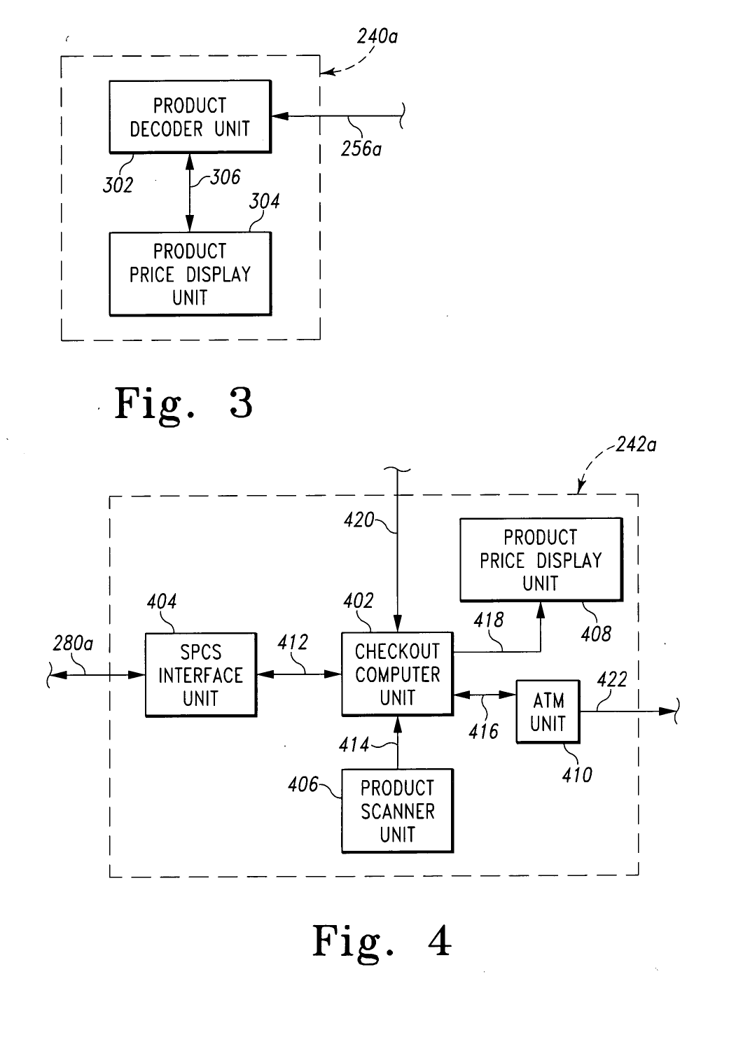

Referring now to FIG. 2 in combination with FIG. 3, the electronic address and product location price data is received by a product decoder unit 302 included in each of the product pricing units 240. It should be understood that each of the product pricing units 240a and 240b are substantially identical in construction and function, and that only the product pricing unit 240a is shown in FIG. 3 for purposes of clarity. The product decoder unit 302 may be a 2.4 GHz spread spectrum RF receiver unit, a magnetic transmission demodulating unit, an IR demodulating unit, or the like. The product decoder unit 302 has an electronic address stored therein. Upon receipt of the electronic address and product location price data from the store product control system 246, the product decoder unit 302 compares the received electronic address with that stored in the product decoder unit 302. When a match is found, the product location price data associated with the electronic address is sent to a product price display unit 304 via a signal path 306.

Upon receipt of the product location price data from the product decoder unit 302, the product price display unit 304 transmits and/or displays the product location price indicative of the unit price of a product disposed adjacent the particular product pricing unit 240 in a format perceivable by a shopper when the shopper is selecting the product for purchase. The product price display unit 304 can be a liquid crystal display, or an LED display, for example. The price display unit 304 may be one of the price display units sold by Tagnetics® Inc., of Dayton Ohio, or from any other manufacturer of similar units. The product location price transmitted or displayed by the product price display unit 304 remains until a new product location price for the particular product located adjacent the product pricing unit 240 is received by the product decoder unit 302. In practice, it is contemplated that to overcome inadvertent mistakes, all the electronic address and product location price data will be transmitted periodically from the store product control system 246 to the product pricing units 240 even though there may have not been any price changes. In addition, it should be noted that the store product control system 246 has the ability to transmit, and the product pricing units 240 have the ability to receive, a special code which changes both the electronic address for the particular product pricing units 240 and/or a price associated with the new electronic address. In this manner, the particular product pricing units 240 become universal.

Referring now to FIG. 2 in combination with FIG. 4, the store checkout station 242a is shown in more detail. The store checkout stations 242a and 242b are substantially identical in construction and function. For purposes of clarity, only the store checkout station 242a will be described in detail herein. The store checkout station 242a includes a checkout computer unit 402. The checkout computer unit 402 has stored therein a product price table which includes a unique code for each of the products available for sale in the store, and a product checkout price associated with the unique code. The unique code for each of the products available for sale in the store can be the UPC code. The product checkout price stored in the checkout computer unit 402 and associated with a single unique code is the price requested from a shopper for the purchase of the product. The store checkout station 242a may also be provided with a product scanner unit 406, an ATM unit 410, a product price display unit 408 and an SPCS interface unit 404. In use, the store system computer 250 outputs product checkout price data to a communication unit 276 via a signal path 278. The communication unit 276 sends the received product checkout pricing data to the store checkout stations 242a and 242b via signal paths 280a and 280b.

As best shown in FIG. 4, the SPCS interface unit 404 receives the transmitted product checkout price data from the communication unit 276. In response thereto, the SPCS interface unit 404 transmits the received product checkout price data to the checkout computer unit 402 via a signal path 412. In response to receiving the product checkout price data, the checkout computer unit 402 is constructed to build or update the product price table stored in the checkout computer unit 402. In use, the shopper selects at least one product for purchase and perceives the product location price displayed by the product price display unit 304 of the product pricing unit 240a, for example. The shopper transports the product to the store checkout station 242a, for example. The UPC code on the product is scanned by the product scanner unit 406 and is thereby input into the checkout computer unit 402 via a signal path 414. The checkout computer unit 402 looks up the product checkout price stored in the product price table by the UPC or unique code identifying the particular product. The checkout computer unit 402 then outputs the product checkout price for the particular product to the product price display unit 408 via a signal path 418 so that the product checkout price for the particular product is perceivable by the shopper. The product checkout price stored in the product price table does not exceed the respective product location price perceivable by the shopper when the shopper was selecting the product for purchase, as will be explained in more detail hereinafter. In any event, once the product which the shopper is purchasing is scanned via the product scanner unit 406, the product checkout price is requested from the shopper for payment. The shopper can pay for the product in any suitable manner, such as by entering their credit card number into the checkout computer unit 402 via an input 420. The shopper's credit card number is then transmitted to a credit card source company for automated payment credit verification via the ATM unit 410 and signal paths 416 and 422. The UPC or unique code identifying each product purchased is batched in the checkout computer unit 402 until the shopper's transaction is complete. At that time, the UPC or unique code data is transmitted to the store system computer 250 via the signal paths 278, 280a, and 412.

Operation of the store product advertising media unit 244 will now be described. The store system computer 250 selectively outputs product advertising data including the unique codes identifying selected products within the store, and a product advertising price indicating an advertised price of the product associated with the unique code to a first modem unit 296 via a signal path 98. The first modem unit 296 receives the product advertising data, and in response thereto the first modem unit 296 outputs such product advertising data to the store product advertising media unit 244 via a signal path 214.

It should be noted that the product advertising data can either be generated by the store system computer 250, and/or can be received by the store system computer 250 from the dynamic pricing system 102 via the network 106, a second modem unit 212, and a signal path 204. The store system computer 250 and/or the dynamic pricing system 102 may be programmed (as explained in greater detail below) so that upon the detection of an increased supply and/or decreased demand for a product or products, the product advertising data is automatically generated and transmitted to the store product advertising media unit 244 to increased the demand for a selected product or products. Alternatively, or in combination with the generation of advertising, the price of the product or products may be lowered, transmitted to the product pricing units 240, and displayed on the product price display units 308.

Referring now to FIG. 2 in combination with FIG. 5, the store product advertising media unit 244 is shown in more detail. The product advertising data may be transmitted from the first modem unit 296 and received by an advertising computer 502. The advertising computer 502 may be loaded with software to cause the advertising computer 502 to selectively communicate with a store print advertising unit 504 via a signal path 504, a store video advertising unit 506 via a signal path 512, and a store audio advertising unit 508 via a signal path 514 to selectively make coupons available for printing, to transmit video messages and audio messages identifying products and product advertising prices indicative of the price to be charged for such products. Only one store print advertising unit 504, store video advertising unit 506 and store audio advertising unit 508 are shown in FIG. 5 for purposes of clarity. It should be understood that the store product advertising media unit 244 can include a plurality of store print advertising units 504, store video advertising units 506 and store audio advertising units 508. The store print advertising units 504, store video advertising units 506 and store audio advertising units 508 can be located proximate to respective individual products to provide the product advertising data (as coupons, video and/or audio “commercial” messages) independently for each individual product, or can be located in a centralized location or locations within the store to provide product advertising data for more than one product at each store print advertising unit 504, store video advertising unit 506 and store audio advertising unit 508.

The store print advertising unit 504 may include an associated video screen with an integrated or separate keypad (not shown) to permit shoppers to browse and select coupons to print. Upon demand, the store print advertising unit 504 may print a set of coupons (or at least one coupon) with each coupon identifying a predetermined price reduction for an identified product or service and also includes other information such as store location, appropriate graphics, colors, and/or a product bar code for checkout and expiration date.

The coupons generated by the store print advertising unit 504 may be given by the shopper to a checkout clerk associated with one of the store checkout stations 242 when the shopper is ready to pay prior to leaving the store. The coupons may be scanned by the product scanner unit 406 at the store checkout stations 242 to provide coupon data, or may be keyed in manually by the checkout clerk. The store checkout stations 242 may transmit the coupon data received from the coupon, such as the identified product to the store system computer 250 via the signal paths 278 and 280. The store system computer 250 may look up a discount associated with the product bar code and transmit the discount to the particular one of the store checkout stations 242 from which the coupon was scanned for inclusion on the respective shopper's printed receipt.

If the coupon presented to the checkout clerk was not printed by the store print advertising unit 504, and product bar code identifying the coupon is not in storage, the store system computer 250 may send a message to the store checkout station 242 where the particular coupon was scanned, so that the clerk at the particular store checkout station 242 can manually enter the product number and discount. The store system computer 250 may also check to ensure that the product identified on the coupon has been scanned via the product scanner unit 406 before authorizing the checkout computer unit 402 at the store checkout stations 242 to deduct the discount amount from the requested product checkout price.

The coupon data, including the product code information, received from the store checkout stations 242 from the scanning of coupons may stored in the store system computer 250. Periodically, the store system computer 250 may accumulate all of the coupon data which has been entered into the store system computer 250 and then sort such coupon data by manufacturer, tabulate the discount amount by manufacturer and then send all of the sorted and totaled coupon data to a printer 224 to generate a physical copy of the coupons and the sorted and accumulated total, as may be required by a redemption center. Because the coupon data is sorted, accumulated and printed, the physical coupons which were scanned by the product scanner unit 406 of the store checkout stations 242 can be discarded at the respective store checkout stations 242.

Overall operation of the communications system 100 will now be described. As mentioned previously, the store system computer 250 receives unique code data identifying purchased products from the store checkout stations 242 via the signal paths 278 and 280. The store system computer 250 forwards this data to the dynamic pricing system 102 via the network 106. In response thereto, the dynamic pricing system 102 may change the prices in the store. The operation of the dynamic pricing system 102 is described in greater detail in the following paragraphs.

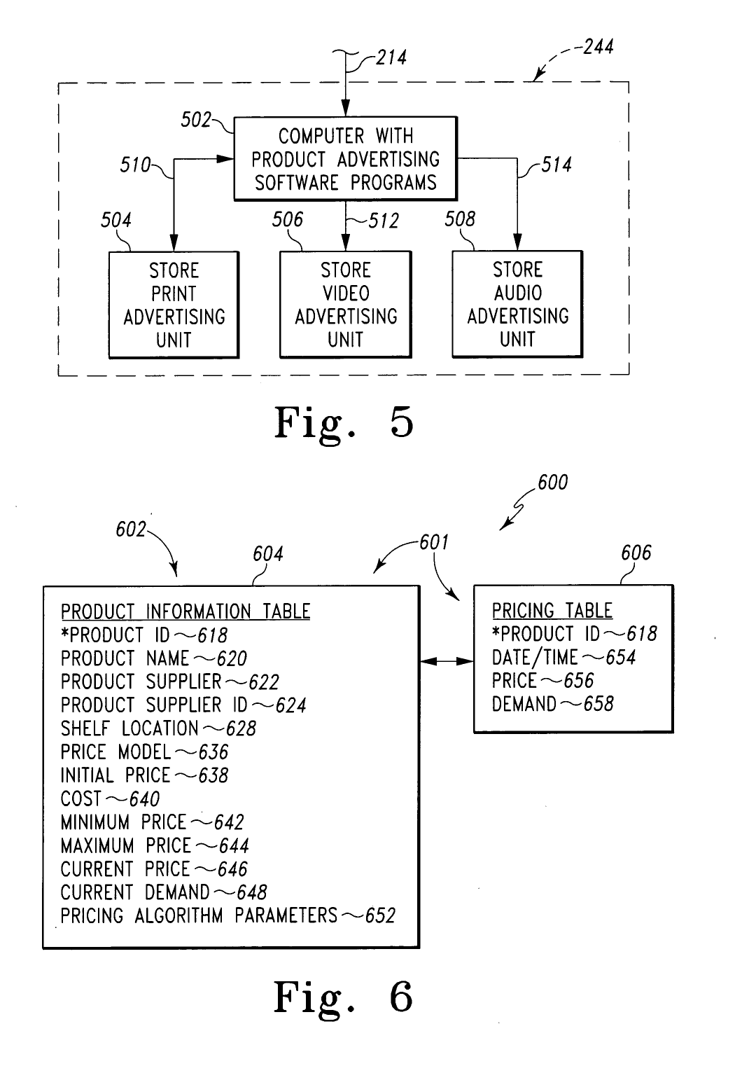

As illustrated in FIG. 6, a database 600 may be maintained to keep track of the pricing data and parameters for products in the store. The database 600 may be stored on dynamic pricing system 102, and may be “mirrored” on store system computer 250 to reduce network traffic. It should be appreciated that the information in database 600 can be encrypted in order to ensure privacy. A table structure 602 of database tables 601 in a database 600 according to one embodiment of the present invention is also illustrated in FIG. 6. As should be appreciated, the database 600 can have different tables 601 and/or table structures 602 other than the ones shown. The tables 601 in the databases 600 include a product information table 604 and a pricing table 606. The product information table 604 stores information about the products in the store. The product information table 604 includes a number of fields 616 that contain information about a particular product. The term “table” as used herein refers to a table of a relational database. It will be appreciated, however, that a record from a non-relational database could be used to provide the same functionality. Therefore, the term “table” should be understood to also refer to records, and vice versa.

As shown, the fields 616 in the product information table 604 can include a product ID field 618 for storing a unique identifier for a product; a product name field 620, which for example stores the name a product; a product supplier field 622 in which the name of the supplier of the product to the store is identified; and a product supplier ID field 624 which contains a unique identifier for individual product suppliers. In FIG. 6, asterisked (“*”) fields in the tables 601 are the fields by which the individual tables 601 are indexed. For instance, the product information table 604 is indexed by the product ID field 618.

The shelf location for a product is stored in field 628. The price model for dynamically pricing the product, the initial price for the product, and the cost or marginal cost of the product are stored in fields 636, 638 and 640, respectively. Fields 642, 644 and 646 respectively store the minimum price for the product, the maximum price for the product and the current price for the product. The current demand, or the number of times the product was purchased within a specified period, is maintained in field 648. Pricing algorithm parameters field 652 can store information such as the historical pricing and quantity ordered information for the product. In one form, field 652 stores the price and corresponding demand for the product over the last seven periods. It should be appreciated that depending on the dynamic pricing technique used, field 652 can store other parameters, such as the time between purchases.

The pricing table 606 stores information related to the price of particular products. The pricing table 606 includes product ID field 618 for identifying the particular product. The date/time, the price at that time, and the quantity demand at that time for the product identified by the product ID field 618 are stored in fields 654, 656 and 658, respectively.

Below a number of techniques for dynamically pricing products on the dynamic pricing system 102 will be described. The dynamic pricing system 102 strives to optimize profit; this typically involves some estimation of the demand curve(s) for the products. The dynamic pricing system 102 in dynamically pricing the products actually never “knows” the demand curve for a product. Generally, the dynamic pricing system 102 continues to raise the price for a product until total profits are reduced. Alternatively, system 102 will decrease the price of a product whenever an increase in price reduces profits. A general description of one embodiment of the pricing algorithm will now be described below. In this embodiment, the dynamic pricing system 102 through processor 110 calculates price adjustments using a logarithmic demand curve that has been found in empirical econometric studies to be the best fitting of algebraically tractable functional form for many retail markets. The quantity of a particular product (q) purchased at a particular price (p) is assumed to take the form of Equation 1 below:
Log[q]=α−βp (Equation 1)
where
Log[ ] is a natural logarithm
q=quantity of a product
p=Price of the product
α, β=parameters.

With Equation 1 above, parameters α and β are unknown. In order to solve these parameters, the technique according to the present invention uses data observed through sales of products to estimate these parameters. Another factor in determining the optimal price for a product is that the demand curve for a product will change over time. Therefore, in one embodiment, the dynamic pricing system 102 does not base its price upon very old data. Still yet another obstacle the dynamic pricing system 102 faces in determining pricing for a particular product is that customer demand at the time periods in which a particular product is demanded varies depending on the nature of a particular product. The profit (profitₜ) made in a particular time period (T) is described below in Equation 2:
profitₜ=q₁(pₜ−c) (Equation 2)
where
t=time period
profitₜ=profit for a particular product at time period t
qₜ=quantity of products sold time period t
pₜ=price of the product at time period t.
c=marginal cost.

It should be noted that for this embodiment the fixed costs are ignored in Equation 2. Equation 2 only considers the marginal cost (c) caused by changes in sales volumes for a particular product. However, it should be understood that in other embodiments fixed costs can be a factor for dynamically pricing a product. Other factors may be incorporated into Equation 2 in order to determine the optimal profit. For example, if the time period (t) was twelve-hours (12 hours), one would expect that more sales would occur during the day as opposed during the middle of the night. This situation could result in undesirable, dramatic price fluctuations. To compensate for the difference between the periods, Equation 2 can factor in one or more additional variables in order to stabilize prices. Alternatively or additionally, the length of the time periods can vary in order to compensate for the differences between the periods. In another form, the price fluctuations between day and night are left alone so that shoppers are given ari incentive to shop at night when sales are typically lower.

With the above background, an example will now be used to describe how prices are dynamically adjusted according to one embodiment of the present invention. In an initial time period (t=1), an initial price for a product is set. For example, the initial price of a product could be set to 90¢ ($0.90), depending on what the administrator using administrative computer 104 believes is appropriate. In this particular example, p₁=$0.90. In the second time period (t=2), the processor 110 of the dynamic pricing system 102 changes the price in order to get a sample of the change in consumer demand at a differing price levels. In the current example, the price of a particular product is raised by 10%, which is shown in equation 3 below.
p₂=p₁+0.10p₁(or p₂=p₁×1.10) (Equation 3)
where p₂=price in the second time period.

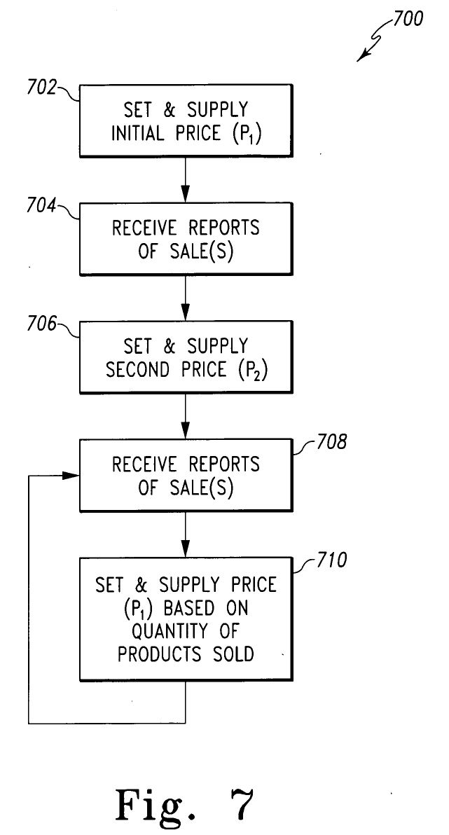

Flow diagram 700 in FIG. 7 illustrates this technique according to one embodiment of the present invention. The technique described below should be understood as applicable to any type of product on the dynamic pricing system 102. In stage 702, the initial price (pₗ) of a product for sale is set by the dynamic pricing system 102 and displayed via product pricing units 240. One or more reports of sales of the product are received by the dynamic pricing system 102 in stage 704, and the dynamic pricing system 102 stores in memory 112 the price (p₁) and quantity sold (q₁) for the first time period. The length of the time periods in this embodiment can for example be by second, by minute, hourly, daily, weekly, monthly, yearly, or some other time increment (e.g., every 33.5 seconds). In one form, the time interval for each period is one day. For instance, the first time period would be day 1, the second time period would be day 2 and the third time period would be day 3. After the first time period, the processor 110 of the dynamic pricing system 102 in stage 706 sets a second price (p₂) for the product and supplies the second price (p₂) for the product to product pricing units 240 (see, Equation 3). The processor 110 in stage 706 can either increase or decrease the price of the product.

For explanation purposes, we will assume that the dynamic pricing system 102 increased the price in stage 706. In stage 708, the dynamic pricing system 102 receives reports of a quantity of sales (q₂) for the product from the store system computer 250. In time period three (t=3), the price and quantity sold information from the previous two periods is used to determine whether the price change from the first period to the second period increased profits or not. If profits increased (q₂(p₂−c)>q, (p₁−c)) then increasing prices further may be profitable. If profit decreases, however, then a price decrease from initial price (p₁) may be appropriate. The changes in prices depend on the functional form of the particular demand curve for the particular product for sale. Using a logarithmic demand curve, Equation 4, which is shown below, can be used to calculate profit.
profit=q(p−c)−Exp(α−βp)(p−c) (Equation 4)

From Equation 4, the profit maximizing price can be determined to be as shown below in Equation 5.

$$p = \frac{( 1 + c )}{β} \qquad ( Equation 5 )$$

A nice property of Equation 5 is that price is not dependent upon unknown parameter α. However, the optimal price still depends on unknown parameter β. As should be appreciated, a number of techniques can be used to estimate the parameters β. In one technique, the two observations of price (p) and quantity (q) are combined from periods one and two to generate an estimate of β. Equations 6 and 7 illustrate this technique.
Log[q₁]=α−βp₁+ε₁ (Equation 6)
Log[q₂]=α−βp₂+ε₂ (Equation 7)
Where ε₁ and ε₂=sampling error.

Equations 6 and 7 can be combined in order to determine parameter β, which is shown below in Equation 8.
β={Log[q₂]−Log[q₁]−ε₂−ε₁}/(p₁−p₂) (Equation 8)

It is assumed that the longer interval time between price changes, the smaller expected sampling error (ε₁, ε₂) would be relative to the quantities sold. Over a long period of time, the expected sampling error terms would be zero. This yields Equation 9 below.

$$β = \frac{\{ Log [ {q}_{2} ] - Log \{ {q}_{1} ] \}}{( {p}_{1} - {p}_{2} )} \qquad ( Equation 9 )$$

The profit maximizing, or optimal price, can be determined by combining Equation 5 with Equation 9, which yields Equation 10 below.

$${p}_{t - 1 , opt} = \frac{( 1 + c ) ( {p}_{t - 2} - {p}_{t - 1} )}{\{ Log [ {q}_{t - 1} ] - Log \{ {q}_{t - 2} ] \}} \qquad ( Equation 10 )$$

Where p_{t-1,opt}=optimal price for time period t−1

In order to prevent extreme fluctuations in pricing between two periods, the change in pricing between two different periods is dampened so that wild fluctuations in pricing do not occur. The amount of dampening can be adjusted depending on the amount of aggressiveness in pricing the administrator intends to use. The estimation of β is highly subject to sampling error. Therefore, to be conservative, a geometric mean between the previous price and the new estimated optimal price may be taken. In addition, absolute bounds on how much a price adjustment between two periods may further be set to further dampen pricing. This is done just in case the estimation procedure gives an inaccurate estimate. A generic form of this technique used by the dynamic pricing system 102 is shown in Equation Set 11 below.

Set
pₜ=pₜ₋₁−L if p_{t-1,opt}<pₜ₋₁−L
pₜ=(pₜ₋ₗ)^{w}(p_{t-l,opt})^{(l-w)} if p_{t-l,opt}≦pₜ₋ₗ−L≦p_{t-l,opt}≦pₜ₋ₗ+L
pₜ=pₜ₋ₗ+L if p_{t-l,opt}>pₜ₋ₗ+L (Equation Set 11)
Where
L=limit bounds
W=weighting factor.

Limit bounds (L) in Equation Set 11 is used to limit how much the price will be adjusted between two periods. For example, if the optimal price for the previous time period is greater than the limit bounds (L) from the actual price, then the dynamic pricing system 102 sets the price for the current time period (Pt) to the limit bound (L) from the previous time period price (pₜ₋ₗ). Weighting factor (W) is used as a geometric mean of weighting the different prices between the optimal and the actual pricing. For example, the weighting factor is used when the optimal price for the previous time period (p_{t-l,opt}) is within the limit bounds (L). The geometric mean of the weighting factor (W) allows the price to move in the direction of the estimated optimal price (p_{t-l,opt}), but forces the price to move slowly. Aggressiveness in price adjustments can be adjusted by adjusting the weighting factor W. The more comfortable the administrator is with the pricing estimates, the more aggressive the pricing can become by adjusting weighting factor W.

For example, at time period one, the dynamic pricing system 102 priced the product at $1.00 (pₗ=$1.00) and the number of the products that were purchased during time period one was 150 (qₗ=150). During time period two, the dynamic pricing system 102 priced the same product at $1.40 (p₂=$1.40) and the number products that were purchased during time period two was 100 (q₂=100). In time period three, the dynamic pricing system 102 determines the optimal price to be the following in Equation 12 (stage 710). In Equation 12, we have assumed the marginal cost of supplying an additional product to be ten cents (c=0.1) for this example.

$${p}_{2 , opt} = \frac{( 1 + c ) ( {p}_{1} - {p}_{2} )}{\{ Log [ {q}_{2} ] - Log \{ {q}_{1} ] \}} \\ {p}_{2 , opt} = \frac{( 1 + 0.1 ) ( 1.00 - 1.40 )}{\{ Log [ 100 ] - Log \{ 105 ] \}} = 1.09 \qquad ( Equation 12 )$$

With the bounds equals $0.50 (L) and weighting factor W=0.8 in this example, the dynamic pricing system 102 uses Equation Set 13 below in order to determine the dynamic price at time period three (p₃).

Set
p₃=p₂−0.50 if p_{2,opt}<p₂−0.50
p₃=(p₂)^{0.8}(p_{2,opt})^{0.2} if p₂−0.50≦p_{2,opt}≦p₂+0.50
p₃=p₂+0.50 if p_{2,opt}>p₂+0.50
p₃=(1.40)^{0.8}(1.09)^{0.2}=$1.33 (Equation Set 13)

In stage 710, the dynamic pricing system 102 with processor 110 sets the revised sale price for the product and stores the price in memory 110. Using the above example, the dynamic pricing system 102 would then set the price of the product to $1.33 in time period three. For subsequent time periods, as sales reports are received in stage 708, the dynamic pricing system 102 continues to periodically re-price the product according to the Equation Set 11.

Equation 14 below is a generic form for another technique of dynamically pricing a product according another embodiment of the present invention.
New Dynamic price=Price Basis×Dynamic Price Modifier (Equation 14)

In Equation 14, the price basis is modified by the dynamic price modifier so as to result in a new dynamic price for a product. In one form, the dynamic price modifier is some measure of change in demand for one or more products being priced. In another form, the dynamic price modifier can take into account profitability of different price levels. It should be understood that the dynamic pricing modifier can take into account other factors. These factors can include, but are not limited to: the marginal and/or fixed costs of the product; price ceilings and/or floors for the product; the popularity of the product as measured by third parties; and reviews of a product. Generally, the dynamic price modifier increases the price of a product when demand for that product increases and reduces the price of a product when the demand for the product decreases. In one form, the dynamic pricing modifier is based on the differences between the quantities sold at specific intervals. For instance, these intervals can be by second, by minute, hourly, daily, monthly, or yearly. In another form, the dynamic pricing modifier is based on the time between successive purchases. For example, if the time delay between successive purchases decreases, the dynamic pricing system 102 can infer that demand is increasing and thus increase the price for the product.

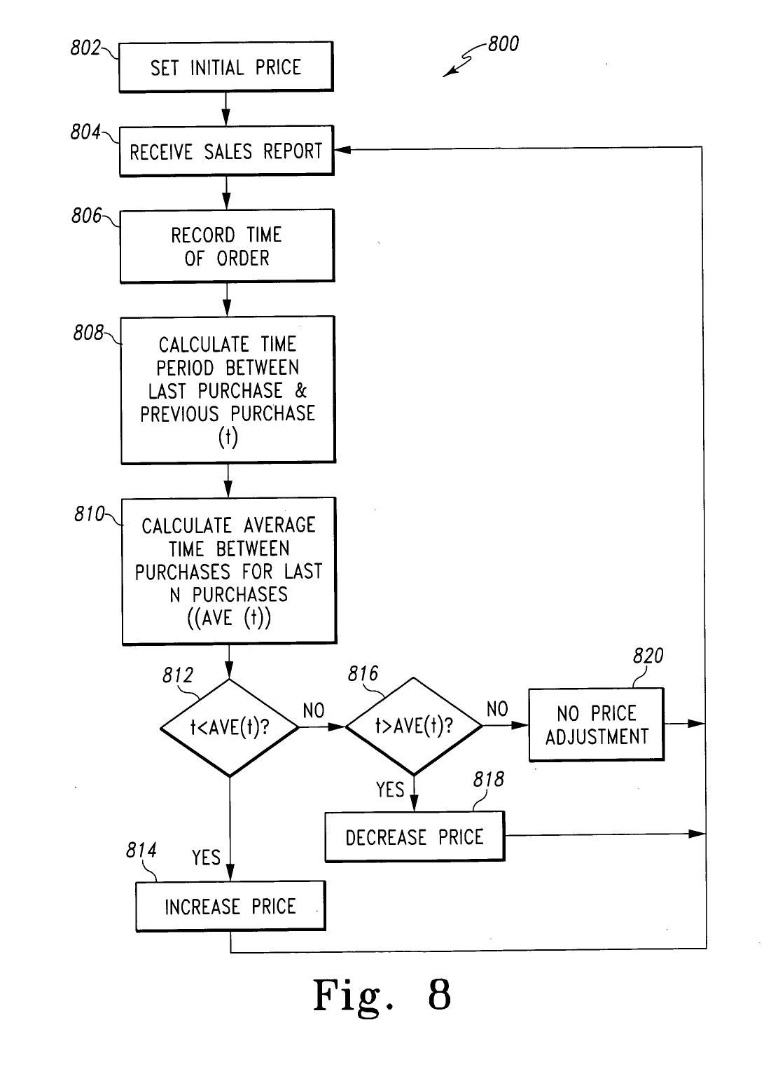

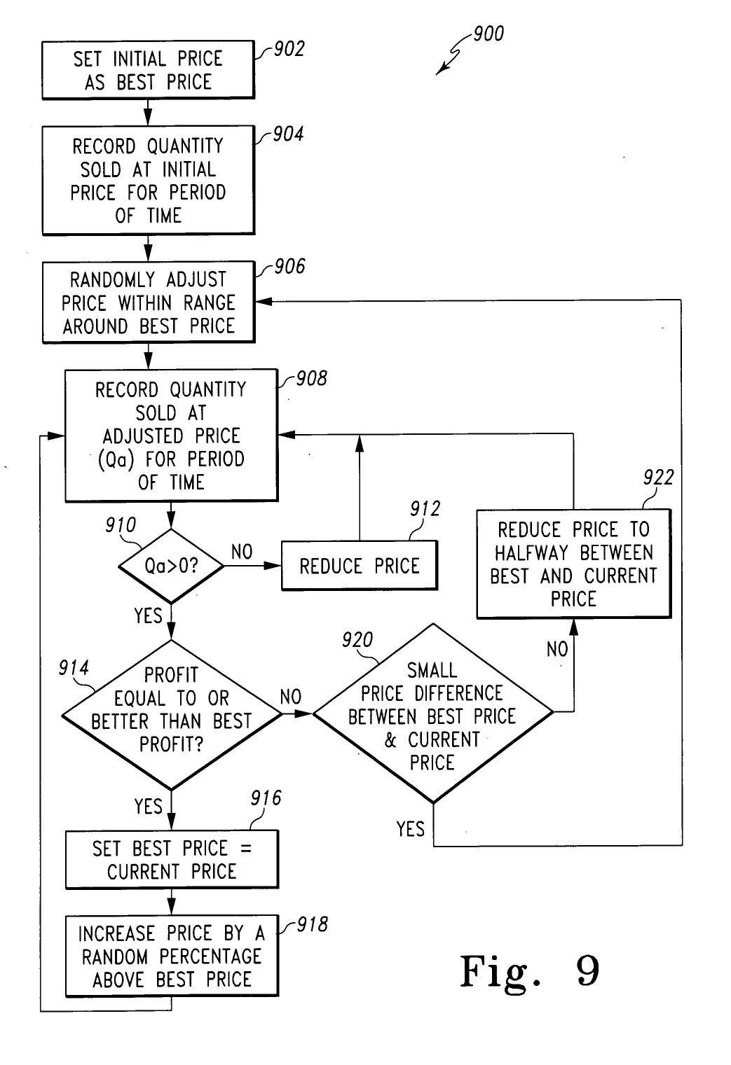

FIG. 8 is a flow diagram 800 that illustrates a technique for dynamically pricing products according to another embodiment of the present invention. In the technique illustrated in FIG. 8, the price of a product is changed based on the time delay between sales of the product. An initial price for the product on the dynamic pricing system 102 is set in stage 802. The system administrator can set the initial price for the product. Alternatively or additionally, the dynamic pricing system 102 in this and other embodiments can automatically set the initial price based on default prices and/or historical prices for similar products stored in memory 112. In one form, the administrator through the administrative computer 104 sets the initial price for a product on the dynamic pricing system 102. In stage 804, the processor 110 of the dynamic pricing system 102 receives a sales report from the store system computer 250 over the network 106. From the clock 11, the processor 110 in stage 806 stores in memory 112 the time the order was received.

In stage 808, the processor 110 determines the time period (t) between the current purchase and the previous purchase of the product. In another form, the clock 111 is reset after each purchase such that the processor 110 stores in memory 112 the time period (t) between the current and previous purchases. Initially, at the first purchase of the product, the time period (t) between purchases can be based on the time delay between when the product was originally available on the dynamic pricing system 102 and when the first purchase was made. The time when the product was first available on the dynamic pricing system 102 can be stored into memory 112 in stage 802. In another form, the processor 110 waits to receive a second order from a customer before calculating the time delay (t) between purchases. It should be appreciated that the dynamic pricing system 102 can record a series of purchase times before dynamically pricing a product.

In stage 810, the processor 110 determines the average time delay ((AVE(t)) between purchases. In one form, the average time delay is calculated for all purchases, and in another form, the average time delay is calculated for a set number (N) of previous purchases so as to take into account shifts in the demand curve. In one particular form, the average time delay is calculated for the last 10 periods (N=10). Equation 15 below illustrates how the average time delay is calculated.

$$AVE ( t ) = \frac{{t}_{i} + {t}_{i - 1} + ⋯ + {t}_{i - N + 1}}{N} \qquad ( Equation 15 )$$

Where
AVE(t)=Average Time Delay Between Purchases
tᵢ=Time delay Purchase Period i
N=Number of Periods

Generally, when the current time delay is less than the average time delay, it can be inferred that demand for the product has increased. Conversely, if the current time delay is greater, then it can be inferred that demand has lowered. In stage 812, the processor 110 of the dynamic pricing system 102 determines whether or not the current time delay between purchases (t) is less than average time delay between purchases (AVE(t)). If the current time delay is less than the average, the processor 110 increases the price of the product in stage 814. In one form of the present invention, the price would be adjusted according to Equation 16 as illustrated below. As can be seen below, Equation 16 is derived from Equation 14.

$${P}_{i + 1} = {P}_{i} \times \frac{AVE ( t )}{{t}_{i}} \qquad ( Equation 16 )$$

Where
Pᵢ₊₁=New Dynamic Price
Pᵢ=Price Basis, or Current Price for Period i.

In Equation 16, the price basis is the price of the product for the latest period, and the dynamic price is the new price for the product. For example, if the price of the product was currently $1.20, the average time between purchases was 20 seconds and the current delay between purchases was 15 seconds, the new price for the product would be $1.60 (1.20×20÷15=1.60). In another form of the present embodiment, the processor 110 takes into account of the upper price, or price ceiling, and lower price, or floor price, for the product. As previously mentioned, the system administrator can specify upper and lower price limits for a particular product. If, for example, the calculated new dynamic price exceeded the upper price limit, the processor 110 in stage 814 would set the new price to the upper limit price. Similarly, if the calculated new dynamic price is less than the lower limit price, processor 110 in stage 818 would set the new price to the lower limit price.

If the current time delay (t) between purchases is not less than the average time delay between purchases in stage 812, then the processor 110 in stage 816 determines whether the current time delay (t) between purchases is greater than the average time delay between purchases. If so, then it can be inferred that demand for the product has lowered, and the processor 110 in stage 818 decreases the price of the product. In one form, the processor 110 reduces the price using Equation 16 (above). For example, if the price of the product was currently $1.20, the average time between purchases was 15 seconds and the current delay between purchases was 20 seconds, the new price for the product would be $0.90 (1.20×15÷20=0.90).

As should be appreciated, the processor 110 can consider other factors, such as the marginal cost, when adjusting the price in stage 818. For instance, in one form, the processor 110 also determines in stage 818 whether the new price is less than the predefined lower price limit, or floor, for the product. If the new price is less than the lower price limit, then processor 110 only sets the new price at the lower limit. In another embodiment, to prevent wild fluctuations in price, the dynamic pricing system 102 in stages 814 and 818 can dampen the price changes between periods. When in stage 816 the current time delay (t) between purchases is not greater than the average time delay between purchases, the processor in stage 820 makes no price adjustment. In another embodiment, to prevent the price from being locked into a local maximum price, the processor 110 in stage 820 randomly adjusts the price.

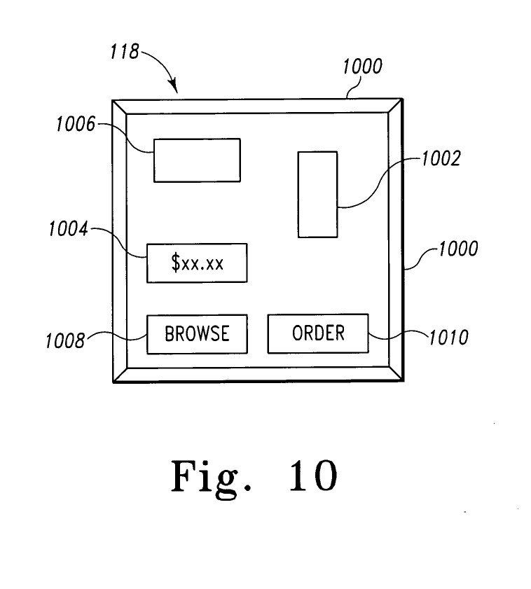

A technique for dynamically pricing products according to another embodiment of the present invention will now be described with reference to flow chart 900 in FIG. 9. In this technique, the database 800 records the number purchases of each product in the dynamic pricing system 102. In one form of this embodiment, a dynamic pricing system 102 periodically updates the prices of each product for sale. The periodic update can be for every second, every minute, hourly, monthly, and/or yearly, to name a few time periods. In one form, the price of individual products is updated nightly. In another form, the prices are updated every minute. Each product for sale and/or type of product for sale can be dynamically priced at different intervals and/or use different pricing techniques depending upon the nature of the product sold. For example, higher priced products, which sell at a slower rate, may have their prices less frequently updated as compared to lower ticket products, which sell at higher volumes. Further, groups of products can be aggregately priced together.

As mentioned above, the system administrator can set the initial price for a product. In stage 902, the dynamic pricing system 102 stores in memory 112 the initial price as the current best price for the product. The processor 110 in stage 904 stores in memory 112 the number of sales of the product at the initial price for a specified time interval and the profit generated (best profit). In one form, the pricing and quantity information is updated daily in the tables 802 of the database 800. After the specified time interval, the processor 110 randomly changes the price within a range around the best price in stage 906. In one form, the dynamic pricing system 102 randomly adjusts the current price within −5% to +5% of the best price. As should be understood, the price can be randomly adjusted within different ranges.

In another form, the price is randomly adjusted without having specified upper range limits. In stage 908, the processor 110 records in memory 112 the quantity order (Qₐ) at the adjusted current price for the same time interval as in stage 904 (for example, daily or every minute). The processor 110 in stage 910 checks to see if the quantity sold in the last time interval was greater than zero (0). If not, the processor 110 in stage 912 reduces the current price. For example, the processor 110 can reduce the price by $0.10 increments when there are no sales of the product within the specified period. In another form, the price is lowered by a percentage of the current price, such as 10% of the current price. If the price reduction in stage 912 would reduce the current price below the lower price limit, when specified, the process 110 sets the current price to the lower limit. As mentioned above, the lower limit may be based in part on the marginal and/or fixed costs for the product. After the price is reduced in stage 912, the processor 110 in stage 908 records the quantity sold at the new reduced price for the specified time interval. In an alternate form, the processor 110 in stage 912 increases the time interval in which the quantity sold is recorded in stage 908. As should be appreciated, the processor 110 can both reduce the price and increase the time interval in stage 912.

When in stage 910 the quantity sold at the adjusted price is greater than zero, the processor 110 determines whether the profit at the current price is at least equal to the best profit stored in memory 112. In one form, the processor 110 determines profit by using Equation 2, above. As should be appreciated, the dynamic pricing system 102 can take into account other factors when determining the profit. For example, these factors can include fixed costs and marginal costs, to name a few. If in stage 914 the current profit is equal to or better than the best profit at the best price, which is stored in memory 112, then the processor 110 in stage 916 sets the current price as the best price in memory 112. In one form, the processor 110 also stores in memory 112 the quantity sold at the now best price such that profit can be calculated. In another form, the processor 110 stores in the memory 112 the current profit as the best profit.

Following stage 916, the processor 110 randomly increases the price for the product within a specified range above the current price. This range limit can be predefined and/or determined through historical data. In one form, the random price is generated within a range from 0% to 10% above the current price. It should be appreciated that the processor 110 can use a number of techniques for generating the random (pseudo-random) numbers as would occur to those of ordinary skill in the art. When an upper limit in price is defined, the price of the product will only be increased to the upper limit price. After the price is increased in stage 918, the processor 110 proceeds to stage 908 and records the quantity sold (Qₐ) at the new adjusted price. By changing the best price in stage 916 even when the current profit is equal to the best profit in stage 914, the dynamic pricing system 102 removes old best prices that may be based on a different demand curve.

In another alternative embodiment, the processor 110 in stage 914 determines whether the profit at the current price is better than the profit at the recorded best price. If so, the processor 110 proceeds to stage 916. If the current profit is equal to the best profit, then the best price remains the same, the current price is not adjusted, and the processor 110 proceeds to stage 908.

When in stage 914 the current profit is less than the best profit, the processor 110 in stage 920 determines whether there is a small price difference between the current price and the best price. The small difference can be based on a percentage basis between the prices and/or by a fixed amount. In one form, the small price difference is less than or equal to a one-percent (1%) change the price. In another form, the small price difference is two-cents ($0.02). It should be understood that other values can be used for the price differential. If there is a small price difference between the current price and the best price, the processor 110 proceeds to stage 906 and randomly adjusts the prices within a range around the best price.

Stage 920 reduces the likelihood that the best price will be stuck at a local maximum in profit. When this problem is not a concern, stage 920 can be omitted. If there is not a small difference in price between the best and current prices in stage 920, the processor 110 in stage 922 reduces the current price to halfway between the current price and the best price. For instance, if the current price is $1.00 and the best price is $0.90, the new adjusted price would be $0.95. As should be appreciated, the price in stage 922 could be reduced by some other fraction of the price differential between the current price and the best price, besides one-half. In one form, if the reduced price is lower than the lower price limit for the product, then the new adjusted price in stage 922 is set to the lower price limit for the product. After reducing the price in stage 922, the dynamic pricing system 102 proceeds to stage 908 and tracks the quantity sold at the new adjusted price. As shown in FIG. 9, the dynamic pricing system 102 using the technique illustrated in flowchart 900 continues to periodically adjust the price of products.

In another illustrative embodiment, the period of time between recording the quantity sold is variable. This technique can be used in the applicable, above-described techniques for dynamically pricing products, but instead “quantity” value in this technique is replaced with “quantity/length of time period” value. For example, in stage 908 of flow chart 900, the “quantity sold/length of time period” value is recorded when the time period is variable. The dynamic pricing system 102 for instance would record one-hundred products per hour (100 products/hour) when one-hundred and fifty (150) products are sold in a one and a half hour (1.5) time period. Recording the “quantity/length of time period” values may improve sampling during slow order periods, such as at night. As should be appreciated, different products for sale on the dynamic pricing system 102 may use different techniques for dynamically pricing the products.

When a product price change is made or received by the store system computer 250, it is important that the price change be implemented in a manner such that the product checkout price requested from the shopper for the purchase of the product at one of the store checkout stations 242 not exceed the product location price displayed by the product pricing unit 240 located proximate to the product so as to reduce consumer irritation with price discrepancies. As will be described hereinafter, the store system computer 250 is programmed to selectively change the product checkout price and product location price in three modes.

In the first mode, as shown in FIG. 2 the physical store systems 214 include a store time-stamp unit 226. Each of the physical store systems 214 can be provided with a single store time-stamp unit 226 provided near the entrance of the store, for example, and/or a plurality of store time-stamp units 226 provided adjacent respective product pricing units 240. The store time-stamp unit 226 communicates with the store system computer 250 via a signal path 228.

Each of the shoppers can be provided with some type of time-stampable media capable of communicating with the store time-stamp unit 226, such as a smart card, or a bar-coded ticket. The store time-stamp unit 226 records, on the time-stampable media, a time stamp data indicative of the time at which the shopper was located adjacent the store time-stamp unit 226 to give an indication of the time at which the shopper perceived the product location price when the shopper was selecting the product for purchase.

When the store time-stamp unit 226 is provided adjacent the entrance of the store, each of the shoppers provides their time-stampable media to the store time-stamp unit 226 to record the time at which the shopper entered the store. When a plurality of store time-stamp units 226 are provided adjacent to the respective product pricing units 240, the shopper provides their time-stampable media to the store time-stamp unit 226 to record the approximate time at which the shopper selected the product for purchase.

For example, one embodiment of the present invention operates as follows. The store system computer 250 outputs a first product location price indicative of the unit price of a product to the product pricing units 240 via the signal paths 254 and 256. The product pricing units 240 receive the first product location price and display the first product location price on the product price display unit 304 such that the first product location price is perceivable by a first shopper when the first shopper is selecting the product for purchase. The store system computer 250 automatically changes the first product location price (based on data from the dynamic pricing system 102) to a second product location price following the first shopper selecting the product for purchase and possibly while the first shopper is still in the store shopping.

The second product location price is then transmitted to the product pricing units 240 via the signal paths 254 and 256 to be displayed on the product price display unit 304. The second product location price is different than the first product location price and is perceivable by a second shopper when the second shopper is selecting the product for purchase. The first shopper then proceeds to one of the store checkout stations 242 to pay for the product which the first shopper has selected. The first shopper provides the time-stamp media to the checkout clerk who enters the time information stored on the timestamp media into the checkout computer unit 402. The UPC code on the product is scanned by the product scanner unit 406 and is thereby input into the checkout computer unit 402. The checkout computer unit 402 then transmits the product identification data (UPC code, RFID code, or the like) and the time-stamp data to the store system computer 250 via the signal paths 278 and 280. The store system computer 250 receives the time-stamp data and the product identification data and determines whether the price of the product reflected in the product identification data was changed after the time reflected in the time-stamp data. If the product location price has been changed after the time identified in the time-stamp data, the store system computer 250 transmits a signal to the checkout computer unit 402 via the signal paths 278 and 280a to request from the first shopper a first product checkout price not exceeding the first product location price perceivable by the shopper when the shopper was selecting the product for purchase.

That is, if the price of the product was increased after the first shopper entered the store or selected the product for purchase (depending on whether the store time-stamp unit 226 was located at the store's entrance or adjacent to one of the product pricing units 240) and had his time-stamp media time-stamped by the store time-stamp unit 226, the first product checkout price will reflect the price of the product before the product location price was increased. However, if the price of the product has been decreased after the first shopper had his time-stamp media time stamped by the store time-stamp unit 226, the first product checkout price will be the decreased price.

In the same manner, the physical store system 214 requests from the second shopper a second product checkout price for the purchase of the product, with the second product checkout price not exceeding the second product location price perceivable by the second shopper when the second shopper was selecting the product for purchase.

In the second and third modes of operation, the store time-stamp unit 226 is not utilized to assure that the product checkout price of a product does not exceed the product location price of the product after a change in the price of the product has been made.

In the second mode of operation, the product checkout price requested from the shopper at one of the store checkout stations 242 for the purchase of a product is changed by the store system computer 250 a predetermined time later than the product location price displayed by the product pricing unit 240 located proximate to the product is changed by the store system computer 250. By changing the product checkout price a predetermined time, such as one hour, later than the product location price, this substantially increases the probability that shoppers will not be charged a price at one of the store checkout stations 242 which is greater than the product location price displayed by the respective product pricing unit 240 when the shopper selected the product for purchase.

In a third mode of the present invention, the product location price and the product checkout price are changed simultaneously by the store system computer 250 when the price of the product is decreased, and the product checkout price is changed a predetermined time later than the product location price by the store system computer 250 when the price of the product is increased.

When a product checkout price of a product is decreased, the decreased price can be transmitted to the store product advertising media unit 244 (as discussed above) to notify shoppers of the price reduction via audio or video. Thus, the store system computer 250 automatically changes both the product checkout price and the product advertised price simultaneously.

Referring now to FIG. 10, the operation of the virtual store system 118 will now be described. As shown in FIG. 10, the virtual store system 118 may include a display screen 1000 illustrating the virtual store system 218 as perceived by a shopper. It should be noted that the virtual store system 218 and the physical store systems 214 may operate more or less identically except as set forth hereinafter. The display screen 1000 of the virtual store system 218 is perceivable by the shopper as the shopper is browsing the Internet, for example. Displayed on the display screen 1000 is at least one product description 1002, and a product price 1004 displaying the product location price of the particular product 1002. Also displayed on the display screen 1000 is a store product advertising media display 1006 which operates identically as the store product advertising media unit 244, hereinbefore described with reference to FIG. 2. Various buttons, such as a browse button 1008 and an order button 1010 are also included on the display screen 1000.

In use, the shopper logs on to the virtual store system 218 and the virtual store system 218 stores a time-stamp indicative of the time that the shopper logged on. The shopper then selects the browse button 1008 to browse between different product descriptions 1002. As the shopper browses through the different screens of product descriptions 1002, the product location price is displayed as the product price 1004, and any advertising specials related to the particular displayed product 1002 or other products are transmitted via video and/or audio transmissions by the store product advertising media unit 1006 to be perceived by the shopper. As the shopper is browsing through the different screens of products 1002, the virtual store system 218 can store a time-stamp indicative of when the shopper first perceived the screen for each individual product 1002 which was browsed.

The virtual store system 218 utilizes either the time-stamp recorded when the shopper logs on, or the time-stamp recorded when the shopper views the screens of the individual products 1002 to set a product order price based on the time-stamp in the same manner as the product checkout price is determined by the physical store systems 114, as hereinbefore described with reference to FIGS. 1 and 2. Once the shopper decides to order one of the products 1002, the shopper presses the order button 1010 and the product location price displayed as the product price 1004 is locked in as the product order price.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1. A method for dynamically adjusting a price, comprising:
sending a first price of a product from a processor to a price display unit positioned near the product;
receiving a report of sale for the product at the first price from a checkout station with the processor;
determining with the processor, based at least on the report of sale for the product at the first price, a first profit at the first price;
determining with the processor that the first profit is less than a previous profit at a previous price;
pricing the product at a second price with the processor; and
sending the second price to the display unit.

2. The method of claim 1, wherein pricing the product at a second price comprises setting the second price as a random percentage above the first price.

3. The method of claim 1, wherein pricing the product at a second price comprises setting the second price to a lower price than the first price.

4. The method of claim 1, wherein pricing the product at a second price comprises setting the second price to a higher price than the first price.

5. The method of claim 1, wherein pricing the product at a second price comprises setting the second price to a price halfway between the first price and a best price at which a best profit was previously obtained.

6. The method of claim 1, wherein pricing the product at a second price comprises:
determining a difference between a best price at which a best profit was obtained and the first price is less than a minimum limit; and
setting the second price to a randomly adjusted price within a range about the best price.

7. The method of claim 6, wherein the minimum limit is one-percent of the best price.

8. The method of claim 1, wherein pricing the product at a second price comprises determining with the processor the second price based on time between sales of the product.

9. The method of claim 1, further comprising receiving a report of sale for the product at the second price.

10. The method of claim 9, wherein pricing the product at a second price comprises determining the second price based on an elapsed time between receiving the report of sale for the product at the first price and receiving the report of sale for the product at the second price.

11. The method of claim 10, wherein pricing the product at a second price comprises determining an average time between receiving reports of sale.

12. The method of claim 11, wherein pricing the product at a second price comprises determining that the time between receiving reports of sale at the first price is less than the average time between orders, and setting the second price to a higher price than the first price.

13. The method of claim 11, wherein pricing the product at a second price comprises determining that the time between receiving reports of sale at the first price is less than the average time between orders, and setting the second price to a lower price than the first price.

14. The method of claim 1, wherein the first price is an initial price.

15. The method of claim 14, further comprising setting the initial price with the processor based on historical data for the product.

16. The method of claim 1, wherein the first price is determined by input from an operator.

17. The method of claim 1, further comprising receiving a minimum price for the product, wherein pricing the product at a second price comprises setting the second price of the product to the minimum price for the product.

18. The method of claim 1, further comprising receiving a cost price for the product from a supplier of the product, and setting a minimum price with the processor based on the cost price of the product.

19. The method of claim 18, wherein pricing the product at a second price comprises setting the second price of the product to the minimum price for the product.

20. The method of claim 1, further comprising receiving a cost price for the product from a supplier of the product, and setting a maximum price with the processor based on the cost price of the product.

21. The method of claim 20, wherein pricing the product at a second price comprises setting the second price of the product to the maximum price for the product.

22. An apparatus, comprising:
a first interface, the first interface operable to send a first price of a product to a price display unit positioned near the product;
a second interface, the second interface operable to receive a report of sale for the product at the first price from a checkout station;
a processor coupled to the first interface and the second interface, the processor operable to determine, based on the report of sale, a difference between a first profit at the first price and a previous profit at a previous price, and to price the product at a second price; and
a third interface coupled to the processor, the third interface operable to send the second price to the price display unit.

23. The apparatus of claim 22, wherein the first interface, the second interface, and the third interface are each a network interface.

24. The apparatus of claim 23, wherein the first interface, the second interface, and the third interface are a single interface.

25. The apparatus of claim 22, wherein the first interface, the second interface, and the third interface are a single interface.

26. The apparatus of claim 22, wherein the processor is operable to format the first price, and to communicate the first price to the first interface.

27. The apparatus of claim 22, wherein the processor is operable to format the second price, and to communicate the second price to the third interface.

28. The apparatus of claim 22, further comprising a memory coupled to the processor, wherein the report of sale comprises a plurality of reports of sale, and the memory comprises software that causes the processor to determine the second price based on a quantity of reports of sale received by the second interface.

29. The apparatus of claim 22, further comprising a memory coupled to the processor, wherein the report of sale comprises a plurality of reports of sale, and the memory comprises software that causes the processor to determine the second price based on an average lapse of time between receptions of reports of sale by the second interface.

30. The apparatus of claim 22, further comprising:
a fourth interface coupled to the processor, the fourth interface operable to receive a cost price of the product from a supplier; and
a memory coupled to the processor, wherein the memory comprises software that causes the processor to set a maximum price for the product based on the cost price of the product.

31. The apparatus of claim 30, wherein the first interface, the second interface, the third interface, and the fourth interface are each a network interface.

32. The apparatus of claim 31, wherein the first interface, the second interface, the third interface, and the fourth interface are a single interface.

33. An apparatus, comprising:
a computer readable medium encoded with a program executable by a computer, the program being executable to cause the computer to:
send a first price of a product to a price display unit positioned near the product;
receive a report of sale for the product at the first price from a checkout station; determine, based at least on the report of sale for the product at the first price, a first profit;
determine that the first price is less than a previous profit at a previous price;
price the product at a second price; and
send the second price to the display unit.

34. The apparatus of claim 33, wherein the program is further executable to cause the computer to determine the second price based at least on a quantity of reports of sale received.

35. The apparatus of claim 33, wherein the program is further executable to cause the computer to determine the second price based at least on a period of time between reception of reports of sale.

36. A signal communicating data with a computer, the data comprising:
a first price of a product sent from the computer to a price display unit positioned near the product;
a report of sale for the product at the first price received by the computer from a checkout station; and
a second price sent from the computer to the price display unit, wherein the second price is determined by the computer, based at least on the report of sale for the product at the first price and on a previous profit at a previous price.

37. A method for dynamically adjusting a price, comprising:
sending a first price of a product from a processor to a price display unit positioned near the product;
receiving a first plurality of reports of sale for the product at the first price over a first period of time from a checkout station with the processor;
calculating a first profit for the first period of time based on the first plurality of reports of sale with the processor;
calculating a profit difference between the first profit for the first period of time and a previous profit for a previous period of time with the processor;
pricing the product at a second price with the processor when the profit difference is greater than zero; and
sending the second price to the price display unit.

38. The method of claim 37, wherein pricing the product at a second price comprises setting the second price as a random percentage above the first price.

39. The method of claim 37, wherein pricing the product at a second price comprises setting the second price to a lower price than the first price.

40. The method of claim 37, wherein pricing the product at a second price comprises setting the second price to a higher price than the first price.

41. The method of claim 37, wherein pricing the product at a second price comprises setting the second price to a price halfway between the first price and a best price at which a best profit was previously obtained.

42. An apparatus, comprising:
a first interface, the first interface operable to send a first price of a product to a price display unit positioned near the product;
a second interface, the second interface operable to receive a first plurality of reports of sale for the product at the first price over a first period of time from a checkout station;
a processor coupled to the first interface and the second interface, the processor operable to calculate a first profit for the first period of time at the first price based on the first plurality of reports of sale and a profit difference between the first profit for the first period of time and a previous profit for a previous period of time, and to price the product at a second price when the profit difference is greater than zero; and
a third interface coupled to the processor, the third interface operable to send the second price to the price display unit.

43. The apparatus of claim 42, wherein the first interface, the second interface, and the third interface are each a network interface.

44. The apparatus of claim 43, wherein the first interface, the second interface, and the third interface are a single interface.

45. The apparatus of claim 42, wherein the first interface, the second interface, and the third interface are a single interface.

46. The apparatus of claim 42, wherein the processor is operable to format the first price, and to communicate the first price to the first interface.
